(19) United States
(12) Patent Application Publication
(10) Pub. No.: US 2007/0186745 A1
(43) Pub. Date: Aug. 16, 2007

(54) Cutting unit for cutting sheet material

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 11/704,264

(22) Filed: Feb. 9, 2007

(30) Foreign Application Priority Data
Feb. 13, 2006 (DE) 20 2006 002 320.8

(51) Int. Cl. B26D 5/00

(52) U.S. Cl. 83/565; 83/745; 30/151

(57) ABSTRACT

The present invention relates to a cutting unit for cutting sheet material. The cutting unit includes a unit body having a lower side, and a rotary cutting device coupled to the unit body. The rotary cutting device has a circular knife mounted rotatably about a shaft. The circular knife is movable between a raised initial position and a lowered cutting position via an actuation device. When the circular knife is in the cutting position, it is shiftable into a cutting location for a cutting operation. The circular knife is movable relative to the lower side such that in the initial position the circular knife does not project beyond the lower side, and in the cutting position does project beyond the lower side. The cutting operation is producible by moving the entire cutting unit over the sheet material.

### CROSS-REFERENCE TO RELATED APPLICATION AND CLAIM TO PRIORITY

This application relates to German utility model application No. 20 2006 002 320.8, the disclosure of which is incorporated herein by reference and to which priority is claimed under 35 U.S.C. §119.

### FIELD OF THE INVENTION

This invention relates to a cutting unit for cutting sheet material, for example paper or films.

### BACKGROUND OF THE INVENTION

Manually actuable cutting units are utilized both in offices and for personal use to trim sheet material such as sheets of paper, photographs, films, etc.; these units are made up substantially of a sheet material support in the form of a support plate that usually entirely receives the sheet material, and a cutting apparatus usually arranged on one side of the support plate. In terms of cutting apparatuses, guillotine cutting apparatuses and rotary cutting apparatuses have become established. The latter comprise a rectilinear guide bar, extending above and parallel to the support plate, on which a rotary cutting device in the form of a knife carriage is shiftable. Arranged in the knife carriage is a circular knife, mounted rotatably on a substantially horizontal shaft, that is movable by means of an actuation device from a raised initial position into a lowered cutting position. The cutting operation is produced by displacing the knife carriage, once the circular knife has assumed the cutting position, along the guide bar. Such cutting units as a whole remains stationary in the process, such as provided in U.S. Patent Publication No. 2002/00923696, or DE 203 18 947 U1.

A rotary cutting apparatus of this kind can also be combined with a guillotine cutting apparatus in order to combine the different capabilities of the two cutting apparatuses with one another in one cutting unit, such as disclosed in EP 1 475 201 A1. Some rotary cutting apparatuses can be displaced on the support plate, and therefore relative to the sheet material that is to be trimmed.

Refinements of cutting units having rotary cutting apparatuses are now on the market. They are notable for the fact that they comprise several different circular knives, for example a circular knife for straight cutting, a circular knife for wavy cutting, and a circular knife for perforations. In a conventionally configured cutting unit having a support plate and guide bar, the three circular knifes are combined into a single rotary cutting device displaceable on the guide bar. The circular knives are distributed, each at an angle of 120 degrees, over the periphery of a rotary member that is rotatable about a horizontal axis. By means of an actuation knob, the respectively desired circular knife can be brought from an initial position into a downwardly projecting cutting position. The housing of the rotary cutting device can be moved downward by means of pressure from above, and the downwardly projecting cutting knife can thus be shifted into a cutting location. The cutting operation is produced by displacing the rotary cutting device along the guide bar.

Another cutting unit includes a set having a cutting mat, a clear acrylic straightedge, and a rotary cutting apparatus that comprises a guide bar mounted on the clear acrylic straightedge and an inventory of three mutually independent rotary cutting devices, in each of which is mounted a circular knife having a different edge. For utilization of the cutting unit, the sheet material to be trimmed is laid onto the cutting mat. The rotary cutting device having the desired circular knife is then slid onto the guide bar from its end, and the unit made up of the clear acrylic straightedge, guide bar, and rotary cutting device is brought, by displacement over the sheet material, into the position desired for trimming. The cutting operation is produced by the fact that the housing of the rotary cutting device having the circular knife is pushed down toward the sheet material and thus into the cutting location, and the rotary cutting device is then displaced along the guide bar. To prevent any relative motion of the clear acrylic straightedge with respect to the sheet material from occurring, the clear acrylic straightedge must also be pressed firmly onto the sheet material. This is cumbersome and does not reliably prevent displacement. The circular knife is changed by replacing the rotary cutting device present on the guide bar with a different one having the desired circular knife.

The known cutting units have the fundamental disadvantage that the respective cut line is determined by the position and profile of a guide bar. In addition, all cutting units of this kind require considerable space, so that they are cumbersome to transport and require a relatively large amount of room.

### SUMMARY OF THE INVENTION

It is the object of the invention to embody a cutting unit that comprises a rotary cutting apparatus that has a single rotary cutting device having one or more circular knives in such a way that any desired cut lines can be implemented using the cutting unit. It is furthermore intended to have a small space requirement.

This object is achieved according to the present invention, in the context of a cutting unit having a single circular knife, in that the circular knife is movable with reference to the lower side of the cutting unit in such a way that in the initial position the circular knife does not project beyond the lower side of the cutting unit, but in the cutting position does project beyond the lower side of the cutting unit, at least after occupation of the cutting location. In the cutting position, the circular knife is fixed with respect to the cutting unit in such a way that a cutting operation is producible only by moving the entire cutting unit over the sheet material. In the context of a cutting unit having a cutting device comprising multiple—e.g. two, three, or four—circular knives, the object is achieved in that the circular knives are movable with reference to the lower side of the cutting unit in such a way that in their respective initial positions the circular knives do not project beyond the lower side of the cutting unit, but in the cutting position do project beyond the lower side of the cutting unit, at least after occupation of the cutting location; and that the circular knife respectively brought into the cutting position is fixed with respect to the cutting unit in such a way that a cutting operation is producible only by moving the entire cutting unit over the sheet material.

The basic idea of the invention is to embody a cutting unit so that the cutting operation can be produced by the fact that the cutting unit as a whole, with a circular knife projecting downward and fixed with respect to the cutting unit, can be moved freely over the sheet material without limitation of the movement by a guidance device, such as the guide bars in the context of the known cutting units of the species under discussion here. Not only is it possible with this cutting unit to create straight cut lines, but it can be moved in any desired directions. This creates the possibility of cutting specific regions out of a sheet material, for example removing desired portions from photos in one working step. This yields a multitude of creative possibilities that could not be implemented with the known cutting units.

In an embodiment of the invention, provision is made for the actuation device to comprise a rotary member which is mounted rotatably with reference to the unit body and to which a rotary motion, with which the circular knife is movable between an initial position and cutting position, can be imparted from outside. No limitation exists in this context as to the direction in which the rotation axis of the rotary member extends; i.e. it can extend, for example, in a horizontal direction. It is also possible, however, for the rotary member to be rotatable about a vertical axis.

It is possible in principle for the circular knife to be arranged on the unit body and for an operative connection to exist between the rotary member and circular knife such that by rotation of the rotary member, the circular knife is movable between the initial position and cutting position. For this purpose the circular knife can, for example, be mounted on the unit body in vertically displaceable fashion, and the displacement can be producible by way of the rotary member. Alternatively thereto, it is proposed that the circular knife be arranged on the rotary member. This can occur, as in the context of the known unit having a single rotary cutting device and multiple circular knives, in such a way that the circular knife is mounted on the rotary member rotatably about a fixed shaft, and the raising or lowering movement occurs by rotation of the rotary member. As a deviation therefrom, provision can be made for the circular knife to be mounted movably on the rotary member, and for there to be provided, between the circular knife and unit body, a guidance device which is embodied in such a way that the movement of the circular knife between the initial position and cutting position is producible by rotation of the rotary member. The guidance device can be embodied, for example, as a gated guide or as a guideway against which the circular knife abuts directly or indirectly under spring preload.

If multiple circular knives are combined in the rotary cutting device, an embodiment can be configured so that each circular knife is coupled to a respective actuation element with which the associated circular knife is movable between an initial position and a cutting position. In this case the rotary cutting device comprises multiple independent circular knives that can be mounted movably, e.g. pivotably or displaceably, on the unit body, and can be moved into the respective position by manipulation of the actuation elements.

Alternatively thereto, it is possible for the actuation device to comprise a rotary member which is mounted rotatably with reference to the unit body and to which a rotary motion, with which the circular knives are movable between an initial position and the cutting position, can be imparted from outside. This can occur in such a way that the rotary member is rotatable about a horizontal axis and the circular knives are arranged, in a manner known per se, distributed over the periphery of the rotary member at preferably equal angular distances, specifically on rotation axes that are stationary with reference to the rotary member.

Alternatively thereto, it is possible to mount the rotary member rotatably about a vertical axis. In this case the circular knives can be arranged movably on the unit body, and an operative connection can be configured between the rotary member and circular knives such that by rotation of the rotary member, one of the circular knives is respectively movable between the initial position and cutting position. Conversely, however, the circular knives can also be arranged on the rotary member, there then being provided between the circular knives and the unit body a guidance device which is embodied in such a way that by rotation of the rotary member, one of the circular knives is selectably movable into the cutting position. In this case the circular knives are held on the rotary member not in stationary fashion but movably, the guidance device providing for movement of the circular knives. The guidance device can be embodied, for example, as a guideway against which the circular knives abut directly or indirectly under spring preload.

The unit body can be embodied, for example, in a cylindrical or hat shape, i.e. in the form of a circular disk having a diameter of at most 15 cm, the rotary member then being mounted inside the unit body. The rotary member should preferably protrude on the lower side from the unit body, and should comprise grip elements there as an actuation device with which the rotary member is rotatable with respect to the unit body.

Provision is further made, according to the invention, for the circular knives to be movable in such a way that they can all be brought, by means of the actuation device, into initial positions in which none of the circular knives projects beyond the lower side of the cutting unit. This neutral position is provided in particular for transporting the cutting unit, and prevents any of the circular knives from causing damage or injury.

In a further embodiment of the invention, it is proposed that the lower side comprise at least one, preferably multiple, flat sliding surfaces for nontilting support of the cutting unit on the sheet material. The flat sliding surface ensures secure manipulation of the cutting unit during the cutting operation.

The invention furthermore provides for the unit body to comprise, in the region in which a respective circular knife is in the cutting position, a cutout which is dimensioned so that the circular knife that is in the cutting position can be replaced through the cutout. Each circular knife should, in the initial position, be completely covered externally by a respective removable cover cap.

The cutting unit according to the present invention is already usable when the respective circular knife that has been brought into the cutting position projects beyond the lower side of the cutting unit, such as when the cutting position and cutting location are identical. This has the disadvantage, however, that the cutting unit may require relatively careful handling so that damage or injury does not occur. To prevent this, it is proposed according to the invention that on the lower side of the cutting unit, at least in the region of the circular knife that is in the cutting position, a protective element be provided to cover said circular knife on at least one side, preferably both sides, the protective element being guided movably between a lower protective position in which the circular knife does not project beyond the protective element even in the cutting position, and an upper enabled position in which the circular knife does project beyond the lower side. A protective element of this kind also prevents the possibility of injuring oneself on the circular knife that is in the cutting position, or prevents damage from being caused thereby. The movable guidance of the protective element allows the protective element to be slid upward relative to the unit body into the enabled position when the cutting unit is placed onto the sheet material, and thus allows the circular knife that is in the cutting position to be enabled for cutting the sheet material, such that only then does it project downward and thus occupy the cutting location.

The protective element can be embodied, for example, as a protective disk that forms the lower side of the cutting unit and preferably is spring-loaded toward the protective position. This ensures that the relevant circular knife is encapsulated at least on one side when the cutting unit is lifted off the sheet material and transported. If the spring loading is stronger than the weight of the cutting unit without the protective element, this furthermore guarantees that the protective position of the protective element is maintained even when the cutting unit is resting with its lower side on the sheet material or on other surfaces. A cutting operation cannot be initiated until pressure is actively exerted on the cutting unit from above toward the sheet material to be trimmed.

According to a further feature of the invention, provision is made for the circular knife or knives to be encapsulated on both sides in the initial position. They should then be enclosed in such a way that injury or damage to objects is prevented in all cases.

Provision is furthermore made according to the invention that the particular circular knife that is in the cutting position is snap-locked, thus ensuring that this circular knife cannot move spontaneously out of the cutting position during the cutting operation. The same provision should also be made for the initial position. The snap-locking should, however, not be so strong that it cannot be overcome by manipulation of the actuation device.

The cutting unit according to the present invention can be of relatively small and compact configuration, so that it can be grasped by a human hand at least to the extent that it can be securely guided with one hand, similarly to a computer mouse, over the sheet material. The cutting unit can be ergonomically adapted to the inner side of a human hand. Other shapes are, however, also possible, particularly shapes that adapt well to the human hand, for example including regular shapes such as circular or disk-shaped embodiments having upper-side convexities, etc.

The particular property of the cutting unit according to the present invention, that it can be guided in freehand fashion over a sheet material that is to be trimmed, does not preclude providing for the cutting unit a guide that allows the cutting unit to be guided in exactly straight fashion or exactly in a predetermined line. For this purpose, the cutting unit can comprise on its lower side guidance protrusions that engage a guide bar that can be laid onto a sheet material and onto which the cutting unit can be placed. For example, the guidance protrusions may fit around the guide bar, when put in place, on both sides and at the top but not at the bottom, and preferably with as close to zero clearance as possible. The guide bar serves here as a kind of straightedge for the cutting unit. The cutting unit can be placed onto the guide bar at any desired location, and then moved along the guide bar. Preferably, at least three guidance protrusions are provided, for example, two guidance protrusions surrounding the guide bar on one side, and a third guidance protrusion surrounding the guide bar on the other side and between the two aforementioned guidance protrusions. In this fashion the cutting unit according to the present invention can also be placed onto a curved, in particular circular, guide bar and moved largely in zero-clearance fashion.

The guide bar is preferably equipped on at least on one side, preferably on both sides, with horizontally extending bracing struts so that it is held securely in its upright position, and cannot tilt. However, it should be understood that the specific configuration of the guide bar is arbitrary. Thus, it may be embodied in straight, curved, or circular fashion.

The invention is illustrated in more detail, with reference to an exemplifying embodiment, in the drawings, in which:

FIG. 1 is a side view of the cutting unit according to the present invention with a view of the cutting portion;

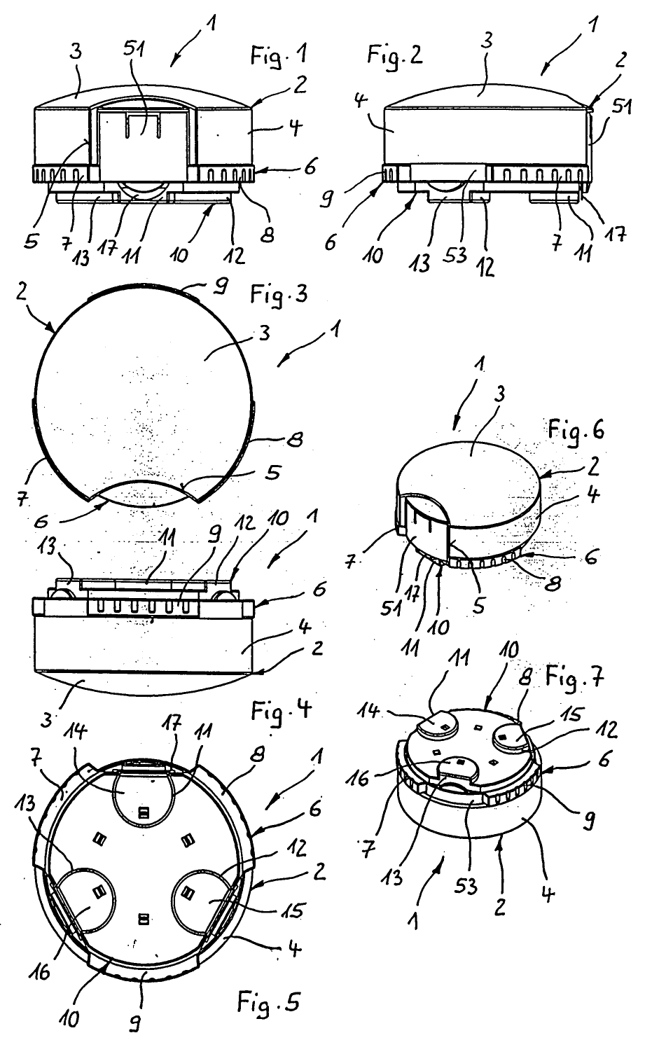

FIG. 2 is a side view of the cutting unit according to FIG. 1, rotated 90° counterclockwise;

FIG. 3 is a top view of the cutting unit according to FIGS. 1 and 2;

FIG. 4 is a side view of the cutting unit according to FIGS. 1 to 3, but inverted with respect to FIG. 1;

FIG. 5 is a bottom view of the cutting unit according to FIGS. 1 to 4;

FIG. 6 is a perspective view, obliquely from above, of the cutting unit according to FIGS. 1 to 5, showing the cutting portion (reduced in size);

FIG. 7 is a perspective view, obliquely from below, of the cutting unit according to FIGS. 1 to 6 (reduced in size);

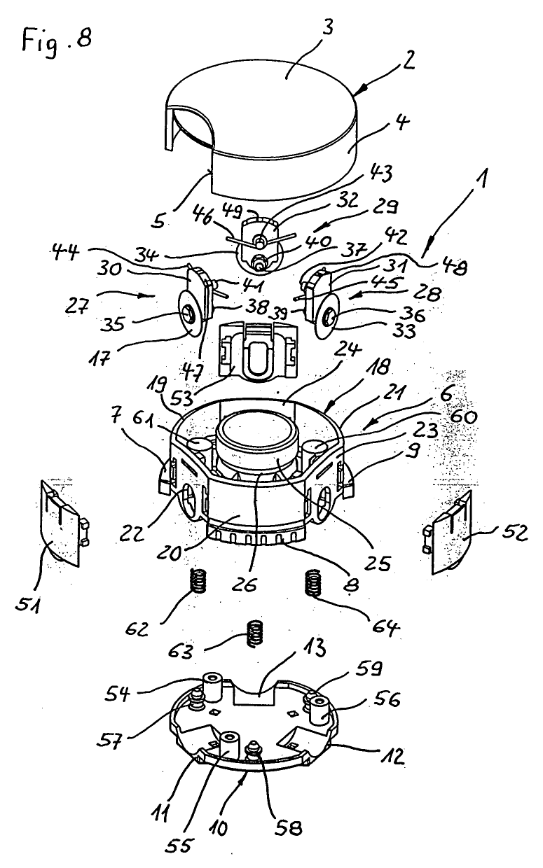

FIG. 8 is an exploded view of the cutting unit according to FIGS. 1 to 7;

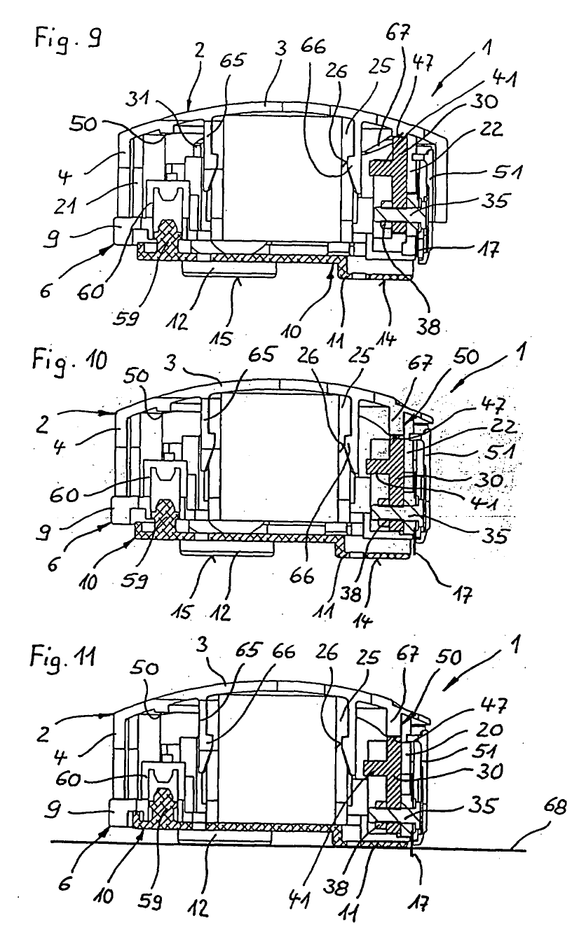

FIG. 9 is a cross section through the cutting unit according to FIGS. 1 to 8;

FIG. 10 is a cross section through the cutting unit according to FIG. 9, but in a plane through the cutting portion with a circular knife in the cutting location;

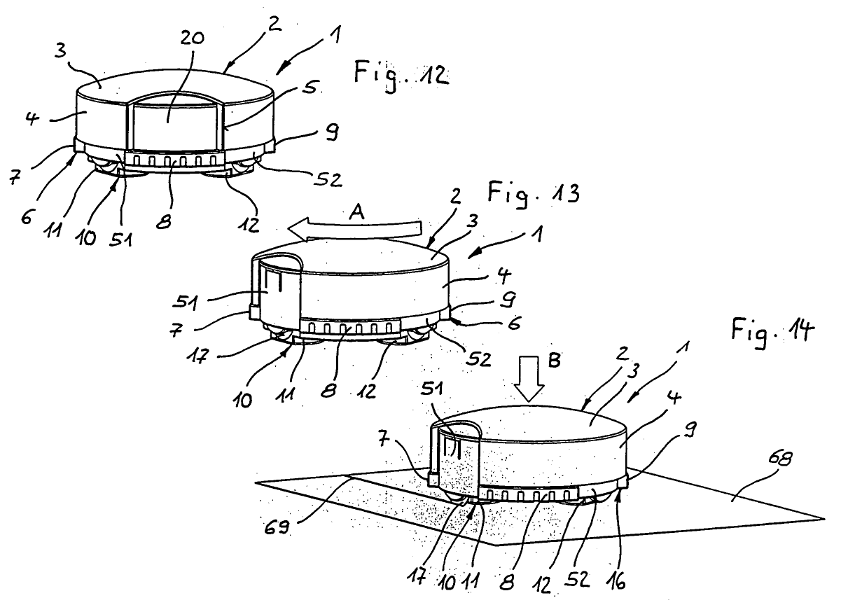

FIG. 11 is a cross section through the cutting unit according to FIG. 10, but placed on a sheet of paper and in a downwardly pressed state, i.e. in the cutting location;

FIG. 12 is an oblique view of the cutting unit according to FIGS. 1 to 11, showing the cutting portion with the circular knives in the initial position;

FIG. 13 is a side view of the cutting unit according to FIG. 12, but with the upper housing part rotated 60° clockwise and with one circular knife in the cutting position;

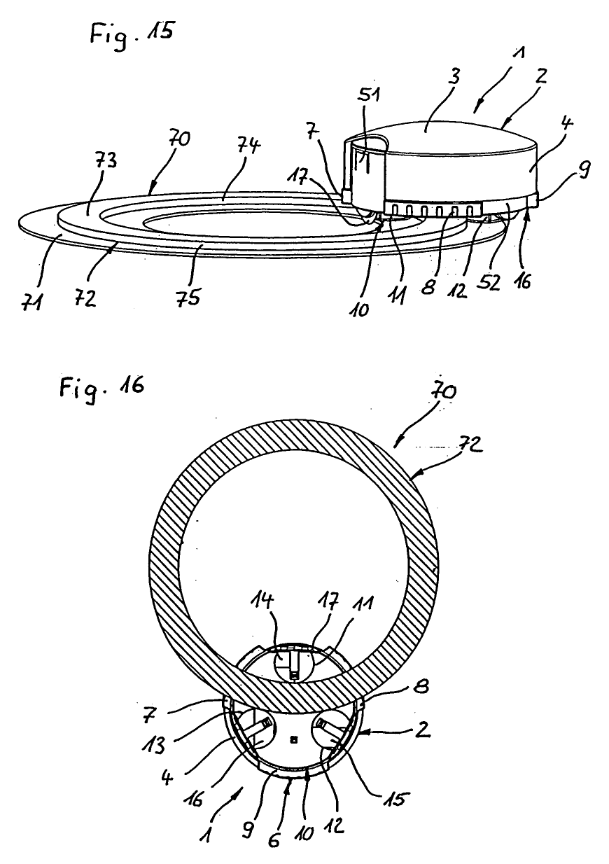

FIG. 14 is a side view of the cutting unit according to FIG. 13 in the cutting location during the cutting operation;

FIG. 15 is a side view of the cutting unit according to FIGS. 1 to 14, placed on a guide bar;

FIG. 16 is a bottom view of the cutting unit according to FIG. 15, with a horizontal section through the guide bar.

### DETAILED DESCRIPTION OF PREFERRED EMBODIMENTS:

Cutting unit 1 depicted in various views in FIGS. 1 to 7 preferably comprises a hat-shaped, or generally cylindrical, unit body 2 that has on the upper side a spherically convex cover wall 3 from whose circular rim proceeds a perpendicularly downwardly extending cylindrical wall 4. Unit body 2 comprises a wall cutout 5, forming a cutting portion, where cylindrical wall 4 is interrupted over a specific angular region.

Inserted from below into unit body 2 is a rotary member 6 whose connection with unit body 2 is described below. Rotary member 6 projects downward out of unit body 2 and forms there fluted grip ridges 7, 8, 9, protruding outward beyond unit body 2, that are distributed at equal angular distances over the periphery of rotary member 6 and at equal distances from one another. They are immovably joined to rotary member 6. By grasping grip ridges 7, 8, 9 with one hand and unit body 2 with the other hand, rotary member 6 and unit body 2 can be rotated relative to one another about a vertical rotation axis.

The lower side of cutting unit 1 preferably includes a protective plate 10 that is guided in a vertically displaceable fashion on rotary member 6 and is held downward by means of springs into a protective position. The springs are sufficiently strong that protective plate 10 remains in the protective position (as shown) when cutting unit 1 is placed, with protective plate 10 downward, onto a surface. Not until pressure is exerted onto the upper side of cover wall 3 toward the surface is protective plate 10 deflected into an enabled position, with the consequence that rotary member 6 and unit body 2 move closer to the surface by a specific amount. Uniformly distributed in the region of the periphery of protective plate 10 are circular guidance protrusions 11, 12, 13 that constitute, on the lower side, flat sliding surfaces 14, 15, 16 on which cutting unit 1 can be displaced in nontiltable fashion over a surface, for example a sheet material to be trimmed.

A rotary cutting device having three circular knives is arranged in rotary member 6. As will be explained below, the three circular knives are arranged at the periphery of rotary member 6, specifically at equal angular distances of 120°. Of the three circular knives, only circular knife 17 is visible in FIGS. 1 and 2, because it is in a cutting position in which it projects downward out of rotary member 6. The other circular knives 17 are in raised initial positions in which they do not protrude out of rotary member 6 but instead are covered on both sides.

FIGS. 8 to 11 depict components of cutting unit 1, including internal components not visible in the assembled cutting unit 1. As shown in particular in FIG. 8, rotary member 6 has an externally located and continuous side wall 18 that comprises, in the region of grip ridges 7, 8, 9, cylinder segments extending upward therefrom. Cylinder segments 19, 20, 21 are connected by substantially straight bearing segments 22, 23, 24, thus resulting in a closed side wall 18. At the axial center, rotary member 6 comprises a coaxially arranged cylindrical cup 25 that is equipped externally with an annular groove 26. This serves, as may be seen in more detail from FIGS. 9 to 11, for connection with unit body 2.

Raised up out of the rotary member in FIG. 8 are three knife elements 27, 28, 29 that are made up substantially of a bearing element 30, 31, 32 and a circular knife 17, 33, 34 rotatably mounted thereon. Circular knives 17, 33, 34 may be configured differently on their edges, so that a straight cut can be produced with one circular knife 17, a wavy cut with second circular knife 33, and a perforation with third circular knife 34. Circular knives 17, 33, 34 sit in freely rotatable fashion on knife shafts 35, 36, 37, which respectively pass through the associated bearing element 30, 31,32 and are locked with a locknut on the side facing away from circular knives 17, 33, 34. In the assembled state, such as shown in FIGS. 9 to 11, knife shafts 35, 36, 37 pass through the respectively associated bearing segments 22, 23, 24;. circular knives 17, 33, 34 end up in front of the outer sides of bearing segments 22, 23, 24, and bearing elements 30, 31,32 abut against the rear side of bearing segments 22, 23, 24.

Bearing elements 30, 31, 32 preferably comprise, in the upper, region pins 41, 42, 43 onto which are placed flexural springs 44, 45, 46, each having two flexural limbs protruding outward and obliquely upward. The flexural limbs are braced (not shown) against corresponding parts of rotary member 6 such that they exert on bearing elements 30, 31, 32 a force directed upward toward unit body 2. With this spring force, bearing elements 30, 31, 32 are pushed with their rounded top sides 47, 48, 49 against a guideway 50, protruding downward and shaped onto the lower side of cover wall 3 of unit body 2, that has a circular profile and is arranged coaxially with the vertical axis of symmetry. Each complete knife element 27, 28, 29 is guided in vertically movable fashion on bearing segments 22, 23, 24, so that knife elements 27, 28, 29 can follow the profile of guideway 50, as shown in FIGS. 9 to 11.

Circular knives 17, 33, 34 are each covered externally by a cover cap 51, 52, 53. Cover caps 51, 52, 53 are joined to the respectively associated bearing segments 22, 23, 24, and do not interfere with the vertical mobility of knife elements 27, 28, 29.

FIG. 8 also depicts the inner side of protective plate 10. Protruding upward therefrom are three guidance columns 54, 55, 56 that, in the assembled state, fit into corresponding guidance cylinders (not visible here) in rotary member 6 and thus ensure exact vertical guidance of protective plate 10 with respect to rotary member 6. Protruding upward next to each guidance column 54, 55, 56 is a respective support column 57, 58, 59. Support columns 57, 58, 59 fit into corresponding support recesses 60, 61 (third support recess not shown) on rotary member 6.

Arranged in the spaces between support columns 57, 58, 59 and the associated support recesses 60, 61 are helical springs 62, 63, 64 (not drawn in FIGS. 9 to 11) that are compressively loaded and are therefore impelled to push protective plate 10 into the protective position already mentioned above.

FIGS. 9 to 11 depict section through cutting unit 1. The section plane through rotary member 6 and protective plate 10 is the same in each case. The respective positions of unit body 2 with reference to rotary member 6 are depicted, in the same sequence, by way of views in FIGS. 12 to 14.

The manner in which rotary member 6 and unit body 2 are coupled to one another is best shown in FIGS. 9 to 11. For this purpose, a cylindrical wall 65 projects downward from the inner side of cover wall 3 of unit body 2 concentrically with the axis of symmetry of cutting unit 1, and externally overlaps cylindrical cup 25 of rotary member 6. Projecting inward from cylindrical wall 65 is an annular flange 66 that fits into annular groove 26 of cylindrical cup 25, annular groove 26 and annular flange 66 being shaped so that unit body 2 can be clipped onto cylindrical cup 25 by being slid onto it. Rotary member 6 is thereby guided rotatably but axially immovably in unit body 2.

In the position according to FIG. 9, knife element 27 abuts bearing element 30 against a portion of guideway 50 that is located close to the inner side of cover wall 3 and extends over approx. 270°. The other knife elements 28, 29, not visible here, also abut against this portion of guideway 50. Between knife element 27 that is shown and knife element 28 that is concealed by cylindrical cup 25 and cylindrical wall 65, guideway 50 has an arc segment 67 protruding downward in curved fashion. The arc is symmetrical in this region, i.e. it reaches its lowest point in this position centrally between the two adjacent knife elements 27, 28. This point is also located at the level of wall cutout 5.

In FIGS. 9 and 12, all the knife elements 27, 28, 29 are in a respective initial position. In the initial position, circular knives 17, 33, 34 are completely covered, on the inner side by the respectively associated bearing segments 22, 23, 24 and on the outer side by the respectively associated cover caps 51, 52, 53. Wall cutout 5 of cylindrical wall 4, visible in FIG. 12, exposes cylinder segment 20, while cylinder wall 4 covers all the bearing segments 22, 23, 24 and therefore knife elements 27, 28, 29 held therein. As known to one skilled in the art, means may be provided such that rotary member 6 is snap-locked with respect to unit body 2 in this position, i.e. the two cannot rotate freely with respect to one another, but instead a certain resistance must be overcome in order to produce a relative motion between the two.

The initial position according to FIGS. 9 and 12 is suitable in particular for transporting and storing cutting unit 1, since in the initial, protective, position, circular knives 17, 33, 34 present no danger of injury and damage. To prepare for a cutting operation, while rotary member 6 is retained using grip ridges 7, 8, 9, unit body 2 is rotated 60° in accordance with arrow A (FIG. 13) into the position shown in FIG. 10. As a result, arc segment 67 runs onto bearing element 30 of knife element 27 and displaces it vertically downward against the action of the associated flexural spring 44 (not depicted here). As a result, circular knife 17 reaches its cutting position projecting beyond the lower edge of cover cap 51, as is also visible in FIG. 1. At the same time, as is likewise apparent from FIG. 1, wall cutout 5 ends up in the region of cover cap 51 and completely exposes it.

A snap-lock engagement may be provided between unit body 2 and rotary member 6 in the cutting position as well, with the consequence that the two parts can be rotated with respect to one another only by the application of force. The snap-lock engagement is sufficiently strong such that a relative motion between unit body 2 and rotary member 6 cannot take place as a result of the manipulation of cutting unit 1 during the cutting operation.

Circular knife 17 that is in the cutting position does not yet project beyond the lower side of cutting unit 1 defined by sliding surfaces 14, 15, 16. Guidance protrusion 11 is located lower down than the lower edge of circular knife 17, and completely covers it from its inner side. In this position, cutting unit 1 can safely be placed and displaced even on sensitive surfaces, for example in order to reach the beginning of a desired cut line. Because helical springs 62, 63, 64 exert a greater force than the weight of unit body 2 and rotary member 6 taken together, protective plate 10 maintains its protective position when cutting unit 1 is placed onto a surface.

In FIGS. 11 and 14, cutting unit 1 is placed onto a sheet of paper 68 to be trimmed. Sheet of paper 68 preferably rests (not depicted here in detail) on a suitable mat, such as a planar matmade of plastic, which may in turn rests on a solid substrate. For the cutting operation, cutting unit 1, first placed onto sheet of paper 68 in the position according to FIG. 10 or 13, is pushed downward by way of pressure on the upper side of cover wall 3 in the direction of arrow B (FIG. 14). As a result, the unit made up of unit body 2 and rotary member 6 is moved downward against the resistance of helical springs 62, 63, 64 until cylindrical cup 25 comes to a stop with its lower side against the inner side of protective plate 10. As a result, circular knife 17 that is in the cutting position moves into a cutting location in which it projects downward beyond sliding surfaces 14, 15, 16 of guidance protrusions 11, 12, 13, and cuts into sheet of paper 68. By displacing cutting unit 1 in a desired direction, sheet of paper 68 can be trimmed (as is evident in FIG. 14). A cut line 69 is created that, by corresponding orientation of the movement of cutting unit 1, can take any desired course.

To terminate the cutting operation, the exertion of pressure onto unit body 2 in the direction toward sheet of paper 68 is discontinued. As a result, the unit comprising unit body 2 and rotary member 6 is brought back into the position according to FIGS. 9, 10 and 12, 13. Cutting unit 1 can then be removed or displaced to a different location on sheet of paper 68, for example in order to initiate a further cutting operation there in the manner previously described.

If what is to be used for the cutting operation is not circular knife 17 but second circular knife 33, unit body 2 is rotated 60° oppositely to arrow A (FIG. 13) out of the position according to FIG. 12, with the result that wall cutout 5 then ends up in congruence with cover cap 52, and arc segment 67 runs onto bearing element 31. The consequence of this is that circular knife 33 is displaced downward into the cutting position. The other two circular knives 17, 34 are then located in their raised initial positions in which they are completely encapsulated, and therefore in protective positions. Trimming of sheet of paper 68 using circular knife 33 can then be carried out analogously to trimming with circular knife 17. The same applies to the case in which third circular knife 34 is to be used for the cutting operation. In this case unit body 2 is rotated 180° out of the position according to FIGS. 9 and 12.

FIGS. 15 and 16 show the use of the cutting unit according to the preceding Figures in conjunction with a circular guide bar 70. Guide bar 70 is made up of a wide base ring 71, protruding upward from which, centeredly and concentrically with respect thereto, is a guidance ridge 72 that is parallelepipedal in cross section and has a horizontal upper side 73 and vertical guidance sides 74, 75. The lower side of base ring 71 is preferably flat, so that guide bar 70 can be placed in planar fashion on the paper to be trimmed. Cutting unit 1 may be placed from above onto guide bar 70. As is evident in particular from FIG. 17, the width of guidance ridge 72 is dimensioned so that, in linear fashion and with little clearance, guidance protrusion 11 abuts against inner guidance side 74, and guidance protrusions 12, 13 against outer guidance side 75, of guidance ridge 72, Cutting unit 1 is thus guided upon displacement along guidance ridge 72. Sliding surfaces 14, 15, 16 slide over base ring 71 on either side of guidance ridge 72.

Cutting unit 1 is in the position according to FIGS. 10 and 13, such that unit body 2 is rotated with respect to rotary member 6 so that circular knife 17 is located in the region of wall cutout 5 and thus in the cutting position. The inside diameter of base ring 71 is sufficiently large, such that cutting knife 17 protrudes into the open inner space. By exertion of pressure onto cover wall 3 of cutting unit 1 in accordance with FIG. 14, circular knife 17 can be placed onto the sheet of paper to be trimmed and can be pushed through it. An exactly circular cut line can thereby be produced by subsequent displacement along guidance ridge 72.

Guide bar 70 may be formed of a polymer material, and may be injection-molded in various diameters. However, it should be understood that guide bar 70 need not be circular. It can also have a finite length and moreover can have any possible profile, for example straight, undulating, etc. Precise profiles of standard cut lines can thereby be achieved.

The possibility of course exists of equipping cutting unit 1 with more than three knife elements, which are then distributed at uniform angular distances over the periphery of rotary member 6. Conversely, second knife element 28 and/or third knife element 29 can also be dispensed with, so as thereby to yield a cutting unit 1 that has only two circular knives 17, 33 or 17, 34 or 33, 34 or only one circular knife 17, 33, 34. There is no change in the fundamental construction of cutting unit 1 as a result thereof.

It will be apparent to one of ordinary skill in the art that various modifications and variations can be made in construction or configuration of the present invention without departing from the scope or spirit of the invention. Thus, it is intended that the present invention cover all such modifications and variations, and as may be applied to the central features set forth above, provided they come within the scope of the following claims and their equivalents.

1. A cutting unit for cutting sheet material, having the following features:
a) the cutting unit has a unit body and a lower side;
b) the cutting unit comprises a single rotary cutting device;
c) the rotary cutting device has a single circular knife;
d) the circular knife is mounted rotatably about an at least substantially horizontal shaft;
e) the circular knife is movable between a raised initial position and a lowered cutting position;
f) the circular knife that is in the cutting position is shiftable into a cutting location for a cutting operation;
g) the cutting unit comprises an actuation device for movement of the circular knife between the initial position and cutting position; characterized by the following features:
h) the circular knife is movable with reference to the lower side of the cutting unit in such a way that in the initial position the circular knife does not project beyond the lower side of the cutting unit, but in the cutting position does project beyond the lower side of the cutting unit, at least after occupation of the cutting location;
i) in the cutting position, the circular knife is fixed with respect to the cutting unit in such a way that a cutting operation is producible only by moving the entire cutting unit over the sheet material.

2. The cutting unit according to claim 1,
wherein the actuation device comprises a rotary member which is mounted rotatably with reference to the unit body and to which a rotary motion, with which the circular knife is movable between an initial position and cutting position, can be imparted from outside.

3. The cutting unit according to claim 2,
wherein the rotary member is rotatable about a vertical axis.

4. The cutting unit according to claim 2,
wherein the circular knife is arranged on the unit body and an operative connection exists between the rotary member and circular knife such that by rotation of the rotary member, the circular knife is movable between the initial position and cutting position.

5. The cutting unit according to claim 2,
wherein the circular knife is arranged on the rotary member.

6. The cutting unit according to claim 5,
wherein the rotary cutting device is arranged movably on the rotary member, and there is provided, between the circular knife and unit body, a guidance device which is embodied in such a way that the movement of the circular knife between the initial position and cutting position is producible by rotation of the rotary member.

7. The cutting unit according to claim 5, wherein the guidance device is embodied as a guideway against which the circular knife abuts directly or indirectly under spring preload.

8. A cutting unit (1) for cutting sheet material (68), having the following features:
a) the cutting unit (1) has a unit body (2) and a lower side;
b) the cutting unit (1) comprises a single rotary cutting device;
c) the rotary cutting device has multiple circular knives (17, 33, 34);
d) the circular knives (17, 33, 34) are each mounted rotatably about an at least substantially horizontal shaft (35, 36, 37);
f) the circular knives (17, 33, 34) are movable selectably from a raised initial position into a lowered cutting position;
g) the particular circular knife (17, 33, 34) that is in the cutting position is shiftable into a cutting location for a cutting operation;
h) the cutting unit (1) comprises an actuation device (6) for movement of the circular knives between the initial position and cutting position; characterized by the following features:
i) the circular knives (17, 33, 34) are movable with reference to the lower side of the cutting unit (1) in such a way that in their respective initial positions the circular knives (17, 33, 34) do not project beyond the lower side of the cutting unit (1), but in the cutting position do project beyond the lower side of the cutting unit (1), at least after occupation of the cutting location;
j) the particular circular knife (17, 33, 34) brought into the cutting position is fixed with respect to the cutting unit (1) in such a way that a cutting operation is producible only by moving the entire cutting unit (1) over the sheet material (68).

9. The cutting unit according to claim 8,
wherein each circular knife is coupled to a respective actuation element with which the associated circular knife is movable between an initial position and the cutting position.

10. The cutting unit according to claim 9,
wherein the actuation device comprises a rotary member (6) which is mounted rotatably with reference to the unit body (2) and to which a rotary motion, with which the circular knives (17, 33, 34) are movable between an initial position and the cutting position, can be imparted from outside.

11. The cutting unit according to claim 10,
wherein the rotary member is rotatable about a horizontal axis and the circular knives are arranged distributed over the periphery of the rotary member at angular distances.

12. The cutting unit according to claim 10,
wherein the rotary member (6) is rotatable about a vertical axis.

13. The cutting unit according to claim 12,
wherein the circular knives are arranged on the unit body, and an operative connection exists between the rotary member and circular knives such that by rotation of the rotary member, one of the circular knives is respectively movable between the initial position and cutting position.

14. The cutting unit according to claim 10,
wherein the circular knives (17, 33, 34) are arranged on the rotary member (6), there being provided between the circular knives (17, 33, 34) and the unit body (2) a guidance device (50) which is embodied in such a way that by rotation of the rotary member (6), one of the circular knives (17, 33, 34) is movable into the cutting position.

15. The cutting unit according to claim 17,
wherein the guidance device is embodied as a guideway (50) against which the circular knives (17, 33, 34) abut directly or indirectly under spring preload.

16. The cutting unit according to claim 2,
wherein the unit body (2) is embodied in a hat shape, and the rotary member (6) is mounted substantially inside the unit body (2).

17. The cutting unit according to claim 16,
wherein the rotary member (6) protrudes downward out of the unit body (2), and comprises grip elements (7, 8, 9) there with which the rotary member (6) is rotatable with respect to the unit body (2).

18. The cutting unit according claim 8,
wherein the circular knives (17, 33, 34) are movable in such a way that they can all be brought, by means of the actuation device (6), into initial positions in which none of the circular knives (17, 33, 34) does project beyond the lower side of the cutting unit (1).

19. The cutting unit according to claim 1,
wherein the lower side comprises at least one flat sliding surface (14, 15, 16) for nontilting support of the cutting unit on the sheet material.

20. The cutting unit according to claim 1,
wherein the unit body (2) comprises, in the region in which a respective circular knife (17, 33, 34) is in the cutting position, a cutout (5) which is dimensioned so that the circular knife (17, 33, 34) that is in the cutting position can be replaced through the cutout (5).

21. The cutting unit according to claim 20,
wherein each circular knife (17, 33, 34) is completely covered externally by a respective removable cover cap (51, 52, 53).

22. The cutting unit according to claim 1,
wherein on the lower side of the cutting unit (1), at least in the region of the circular knife (17, 33, 34) that is in the cutting position, a protective element (10) is provided to cover said circular knife (17, 33, 34) on at least one side, the protective element (10) being guided movably between a lower protective position in which the circular knife (17, 33, 34) does not project beyond the protective element (10) even in the cutting position, and an upper enabled position in which the circular knife (17, 33, 34) projects beyond the protective element (10).

23. The cutting unit according to claim 22,
wherein the protective element is embodied as a protective disk (10) that forms the lower side of the cutting unit (1).

24. The cutting unit according to claim 22,
wherein the protective element (10) is spring-loaded toward the protective position.

25. The cutting unit according to claim 24,
wherein the spring loading is stronger than the weight of the cutting unit (1) without the protective element (10).

26. The cutting unit according to claim 1,
wherein the circular knife or knives (17, 33, 34) is/are encapsulated on both sides in the initial position.

27. The cutting unit according to claim 1,
wherein the particular circular knife (17, 33, 34) that is in the cutting position is snap-locked.

28. The cutting unit according to claim 1,
wherein the circular knife or knives (17, 33, 34) is/are snap-locked in the initial position.

29. The cutting unit according to claim 1,
wherein the cutting unit (1) is graspable by a human hand.

30. The cutting unit according to claim 1,
wherein the cutting unit (1) comprises guidance protrusions (11, 12, 13) on its lower side, and there is associated with the cutting unit (1) a guide bar (72) that can be laid onto a sheet material (68) and onto which the cutting unit (1) is placeable, the guidance protrusions (11, 12, 13) fitting around the guide bar (72), when put in place, on both sides and at the top but not at the bottom.

31. The cutting unit according to claim 30,
wherein at least three guidance protrusions (11, 12, 13) are present, two guidance protrusions (12, 13) being provided for surrounding the guide bar (72) on one side, and one guidance protrusion (11) for surrounding the guide bar (72) on the other side between the two aforementioned guidance protrusions (12, 13).

32. The cutting unit according to claim 30,
wherein the guide bar (72) is equipped at least on one side with a horizontally extending bracing strut.

33. The cutting unit according to claim 30,
wherein the guide bar (72) is embodied in straight, curved, or circular fashion.
